(19) United States
(12) Patent Application Publication
(10) Pub. No.: US 2014/0147806 A1
(43) Pub. Date: May 29, 2014

(54) METHOD AND SYSTEM FOR DENTAL IMPLANT SURGICAL GUIDES

(71) Applicant: Fei Gao, Cypress, CA (US)

(72) Inventor: Fei Gao, Cypress, CA (US)

(21) Appl. No.: 13/685,165

(22) Filed: Nov. 26, 2012

(51) Int. Cl. A61C 8/00

(52) U.S. Cl. CPC A61C 8/009
USPC 433/173

(57) ABSTRACT

A dental implant surgical guide, its design method and system. A surgical guide has an adaption surface to fit onto patient's oral dental anatomy, as well as holes to guide the drills and to provide depth control to the drilling operations. In prior art, drill guiding holes have to be specifically designed and made for a targeted surgical kit. In this invention, a series of preferred diameters are predefined for the drilling holes or sleeves, a surgical guide is designed for the preferred diameters and a universal surgical kit is designed accordingly. Indexing geometric features are added to the surgical guide to indicate the key parameters for drilling depth control. As a result the surgical guide and universal surgical kit can be used with any implant brands. Software system designing such surgical guides includes components to generate base model, define and select preferred diameters, add form features, and export treatment plan with plan adaption instructions.

### CROSS-REFERENCE TO RELATED APPLICATIONS

Fei Gao 12/795,045 July 2010

### REFERENCE CITED

### US Patent Documents

| | | |
|---|---|---|
| Karkar, et al. | 2010/0105011 | April 2010 |
| Michael Poirier | 6,814,575 | September 2004 |
| Trevor Bavar | 8,105,081 B2 | January 2012 |
| Bart Swaelens, et al. | 5,768,134 | October 1996 |
| Daniel R. Llop et al | 12/683,319 | January 2010 |
| Jerome Haber | 12/818,522 | January 2010 |

### Other Publications

NobelBiocare, NobelGuide: Concept manual for guided surgery, 2011

### U.S. Classification: 433/75

Field of search: 433/72, 75, 76 433/172,173

### FIELD OF THE INVENTION

This invention concerns the surgical guide design and accompanying surgical kits for image-guided dental implant treatment. A surgical guide is usually designed according to the specification of a selected surgical kit and implant platform. In this invention the surgical guides are designed independent of implant brands and their surgical kits, used with a universal surgical kit, and can be adapted even if treatment plans have to be modified after the guides are made. This gives the doctors the flexibility to choose implants, and to adjust treatment plans.

### BACKGROUND OF THE INVENTION

An image-guided implant planning solution designs and makes surgical guides, which have drill guiding holes and will fit onto patients' anatomy so that the doctors can drill implant holes with the guidance of those holes, and the implants can be placed at the planned locations and orientations. The surgical guides are used together with surgical kits in actual treatment. A surgical kit in this disclosure means the drills and any other hand pieces to guide the drilling operations together with surgical guides. It should not be considered as a package of models and tools customized for individual patient and deliver to doctors, as in US-2010/0105011 by Karkar, et al.

The existing patent disclosures and publications are mainly concerned of the geometric shape of the surgical guides, how they are created from CT scan or other data source, and how hole locations and orientations on the surgical guides can be derived from the treatment plans, but not how the parameters are chosen. Poirier (U.S. Pat. No. 6,814,575) discussed the basic idea of inferring surgical guide model from jaw bone and tissue images, and a device to drill holes. Surgical kit and guide parameters are not discussed. Trevor (U.S. Pat. No. 8,105,018B2) introduced rotational position indicators on a surgical guide. Swaelens, et al. (U.S. Pat. No. 5,768,134) investigated the approach to make surgical guides with focus on how the base model is derived from imaging data so that the model can sit on the patient's anatomy. Llop (U.S. Ser. No. 12/683,319) designed surgical guides with open-sized slots instead of drilling holes. Harbor (U.S. Ser. No. 12/818,522) suggested a surgical guide design that uses two holes on two thin layers to guide the drills. In published software systems, the surgical guide design is, typically not a part of the treatment planning software. Manufacturers design and make surgical guides in house for various surgical kits, such as those from Nobel Biocare, Biomet 3i, etc. Gao (U.S. Ser. No. 12/795,045) introduced an integrated system for treatment planning and surgical guide design according to surgical kits. All of the publications imply that the drill-guide holes have the same diameter as the implants, or, have the sizes that surgical kits required.

In order for a surgical guide to be used in a treatment, it has to be designed for a specific surgical kit. FIG. 1 illustrates this concept. The surgical guide is the piece of model (shaded in the figure) placed onto the patient's oral-dental anatomy. A guide has a base model 0, an adaption surface 1 and holes where metal tubes as 8 (also known as drilling sleeves) are inserted into and glued to the base model. The inner diameter of a drilling sleeve ID is same as the diameter D of the implant, or corresponding drill of a surgical kit. For some surgical kit, so called implant mounts are used, which is typically bigger than the implant itself, the drilling sleeves need to have the same size as the implant mounts.

An image guided surgical kit includes a lot of components as indicated in “NobelGuide: Concept manual for guided surgery”. As far as the drill guidance is concerned, the interested parts include drills as item 11, 12 and 13, and drilling keys as item 5, 6 and 7 in the figure. A drill corresponds to a drilling step in a surgery. An implant drilling typically can include two or three steps, so two or three drills will be used. Since a surgical guide is normally designed for the last drilling step, drilling keys are inserted into surgical guides to provide guidance to the pilot and intermediate drills accordingly. In the remainder of this disclosure, a surgical kit refers to a set of drills and their corresponding drilling keys.

There are flexibility issues with such an approach where a surgical guide is designed for the surgical kit corresponding to implant brands. First, when a surgical guide is designed, a surgical kit has to be specified, and later on the surgeon has to use this surgical kit. A surgeon typically uses only implants from one or two manufacturers. If he/she wants to mix implant platforms, he/she has to get all kinds of surgical kits, which is however not practical because there are so many implant manufacturers, each of them has various implant sizes, and there is no standard size series in the industry, nor universal surgical kits. Moreover, for the surgical guide manufacturing, the metal drilling sleeves have to be made for various implant sizes and their corresponding surgical kits. In most situations, the batch volume of specific drilling sleeves is extremely low, which practically prevents small manufacturers or dental labs from offering surgical guide manufacturing services at reasonable price. No publication has been found that tries to address this issue.

### BRIEF SUMMARY OF THE INVENTION

The design of a surgical guide has essentially two components, as indicated in FIG. 1: a base model 0 with adaption surface 1, and drill guiding holes for implants. One hole is needed for one implant. The base model fits onto patient's anatomy. A drill guiding hole has a cylindrical surface 2 that guides a drill, and a top planar face 3 that stops the drills. Most of the time, the drill guiding holes are realized be drilling sleeves, which are cylindrical tubes as the part 8.

When a doctor drills an implant hole, he/she will drill a couple of times, from small diameter to the final size. The series of drilling is called drilling sequences. The drills are called pilot drill, intermediate drill or final drill. The final drill has the size of the implant. The drilling operations between pilot drill and final drill are referred as intermediate drills.

The diameter of the cylindrical hole 2 is determined by the implant size and surgical kit. For example in FIG. 1, assuming the implant size is 3.75×10 mm, the surgical kit has a drill of 3.75 mm, and its top (or implant mount) is 4.25 mm, so the diameter of this cylindrical hole 2 needs to be 4.25 mm, and the surgical kit will have other tools like 5, 6 and 7 inserted into the surgical guide so that the drill of 3.75 mm or smaller can be actually guided by this hole. The outer diameters of the sleeve in part 5, 6 and 7 are all 4.25 mm for this example. On the other hand as in FIG. 1 the distance between the implant top face 4 and the surgical guide face 3 is called prolongation of the surgical kit. A typical value is 9 mm. With this prolongation defined, the drilling depth in this example will be 19 mm, which is the sum of the prolongation and the implant length. In summary FIG. 1 illustrates the prior art of designing surgical guides based on surgical kits.

This invention first addresses the choice of diameters of the drill guiding holes in FIG. 1. Practically it is not necessary to use a surgical guide and surgical kit to drill implant holes of all diameters. A surgeon can just drill a hole of 3.5 mm using a surgical guide, and then drill it to 3.75 mm without a guide. The size 3.5 mm in this case is called the preferred diameter of the 3.75 mm implant. The 3.5 mm drill is called preferred drill. This disclosure is essentially to design surgical guides according to the preferred diameters. There need to be a series of preferred diameters in order to accommodate different implant diameters.

Secondly this invention addresses the prolongation issue. Shown in FIG. 2 illustrates that a predetermined prolongation value may not be appropriate. From the guide design one can tell that the drilling sleeve will penetrate through the adaption surface and into the patient's soft tissue. The part under the adaption surface has to be trimmed, thus effective drill guide height is too short to provide a good guidance to the drilling operations. The solution is to customize the prolongation value. If the value is increased enough, the sleeve will be moved up so as to well serve the purpose of the guidance. With a prolongation value customized, geometric form features will be added to the surgical guide to indicate this customization. For example, a slot can be created on the model to indicate that prolongation is 10 mm, and two slots for 11 mm. Such slots are called indexing features.

As a result, a surgical guide designed with the said method will include a base model, prolongation indexing features and drill-guiding holes, the diameters of which are not implant diameters but the preferred diameters. Treatment plan accompanying such a surgical guide will include drilling instructions accordingly.

A universal surgical kit accompanying such a surgical guide is then introduced. The kit includes drills and drilling keys that are designed based on the preferred diameters other than the actual implant brand.

A computer system to design surgical guides with this approach includes a base model creator, a preferred diameter selector, a feature modeler to add holes, drilling sleeves and prolongation indexing features, as well as a treatment plan generator that creates drilling instructions according to the guide design and the universal surgical kit.

### DESCRIPTION OF THE DRAWING

FIG. 1 illustrates the idea that surgical guide is designed for specific implant platform and its surgical kit.

FIG. 2 is an example that a drill prolongation value specified by a surgical kit can be sometimes an invalid choice in guide design, and has to be changed.

FIG. 3 gives an embodiment of so-called preferred diameters, and their mapping to the ranges of implant sizes.

FIG. 4 illustrates the idea to reduce the number of different sizes of drilling sleeves. For a full spectrum of implant sizes, the number of external diameters of drilling sleeves are reduced to just a few, and further reduced if desired.

FIG. 5 gives a few examples of the indexing features that are added to surgical guide design to indicate the prolongation values for individual implants.

FIG. 6 illustrates the drilling keys for an universal surgical kit.

FIG. 7 illustrates a drilling sequence includes one pilot drill, any number of intermediate drill, one preferred drill and one final drill with the surgical guide design in this invention.

FIG. 8 shows how a surgical guide design can adapt itself to treatment plan modifications.

FIG. 9 shows the components of a computer system to design surgical guides according to the preferred diameter approach.

FIG. 10 shows the components of the design software and the procedure a guide is designed.

### DETAILED DESCRIPTION OF THE INVENTION

### The method

In surgical guide design, a base model will be first created to fit onto the patient anatomy before geometric features are added. There have been various approaches to generate a base model, and to add additional form features. This is not the topic of this invention, so it is assumed that a base model has been created. Usually drilling sleeves will be inserted into a surgical guide model. They can prevent the guide from being cut. There could be various designs of the sleeves. This invention does not limit the actual geometric design of the drilling sleeves. Only the three key parameters of a guide-drilling hole or sleeve are concerned: inner diameter, thickness, and height.

Implant diameters vary from one manufacturer to another. There is no standard dimension series. Surgical guides and their targeted surgical kits from manufacturers are designed to drill implant holes to those diameters.

A series of diameters are defined as an arithmetic progression in an embodiment. The diameters start from 1.5 mm, and increase by 0.5 mm each step, up to 7 mm. There's barely any implant bigger than that, but new sizes can be added if needed. These diameter values are called preferred diameters. For any given implant, its preferred diameter is the closest and smaller one in the series. For example, a 3.4 mm implant has a preferred diameter of 3.0 mm.

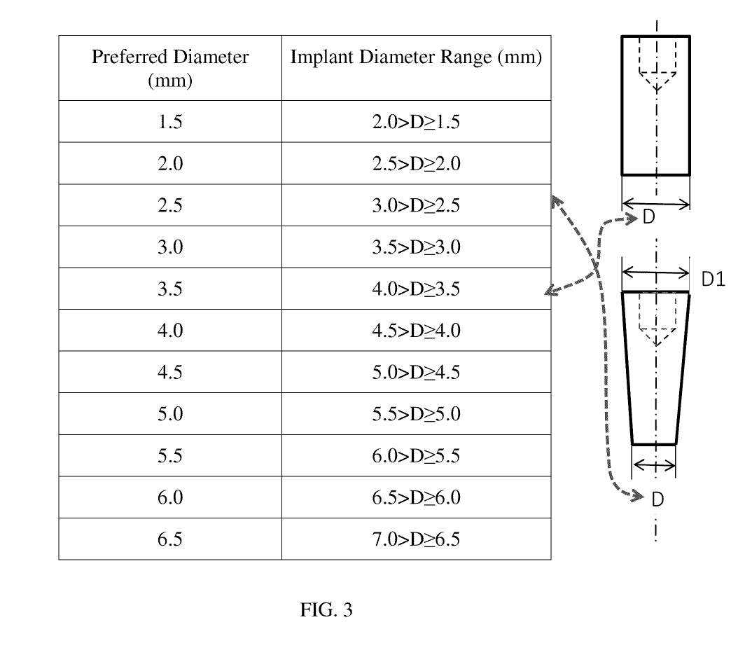

An embodiment is shown in FIG. 3. The first column lists the preferred diameters, the second the implant diameter ranges corresponding to preferred diameters. The numbers in this figure are for illustration purpose only. In an actual embodiment, a system or implementation can define different preferred diameters, for example, starting from 2 mm, and increasing by 1 mm each step.

For an implant without tapering, its diameter at the top and the bottom are essentially the same. Its preferred diameter can be located by looking up the preferred series such as the table in FIG. 3. A tapered implant, as shown in the figure, has two diameters: D1 for the top and D for the bottom. D is used to look up the preferred diameter.

The reason to introduce preferred diameter is that an implant hole can be drilled up to its preferred diameter using a surgical guide, and then drilled to the final size without a surgical guide. In this invention, drill-guiding holes, or the drilling sleeves, are designed for the preferred diameters other than the actual implant sizes. This way the guide design is limited to the preferred diameters instead of all the possible implant sizes.

Reducing the variations of drilling sleeves is also an objective. One approach is to have a uniform thickness for all the sleeves. The goal of doing so is to reduce the number of possible sizes of the sleeves and thus to reduce the manufacturing cost. In prior art where surgical guides are designed according to surgical kits, the drilling sleeves have to match implant diameters (NobelGuide, Concept manual for guided surgery, 2011).

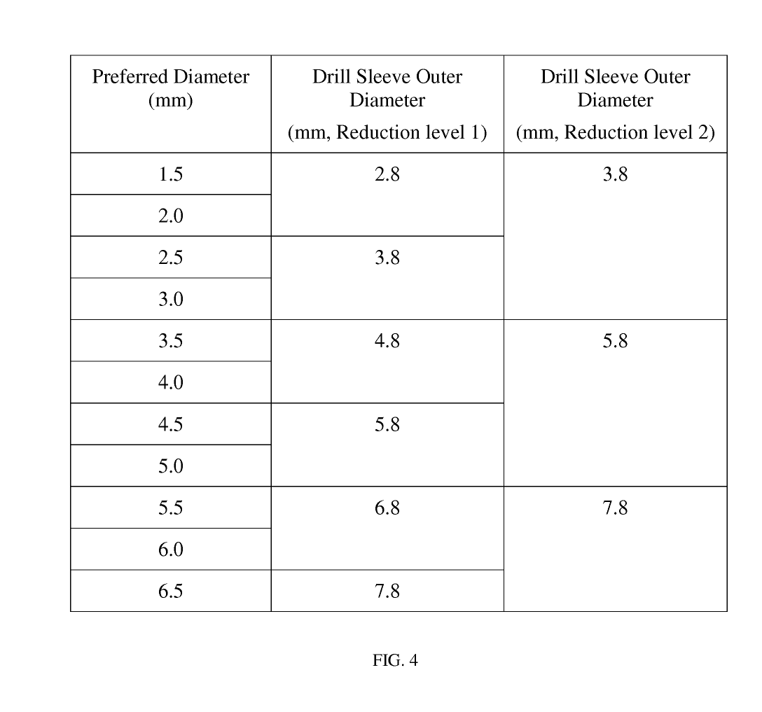

FIG. 4 illustrates another approach to reduce the variations of the drilling sleeve design. For any given two consecutive preferred diameters, say 3.5 mm and 4 mm, drilling sleeves will have same external diameter, such as, 4.8 mm. By doing this, the needed number of external diameters will be reduced. As in this figure, there will be external diameters of 2.8 mm, 3.8 mm, 4.8 mm, 5.8 mm, 6.8 mm and 7.8 mm. Considering there are dozens of implants of different diameters from different vendors, this greatly improves the manufacturability and reduces the cost. In another embodiment, as shown as “reduction level 2” column, the external diameters are further reduced to 3.8 mm, 5.8 mm and 7.8 mm in this example.

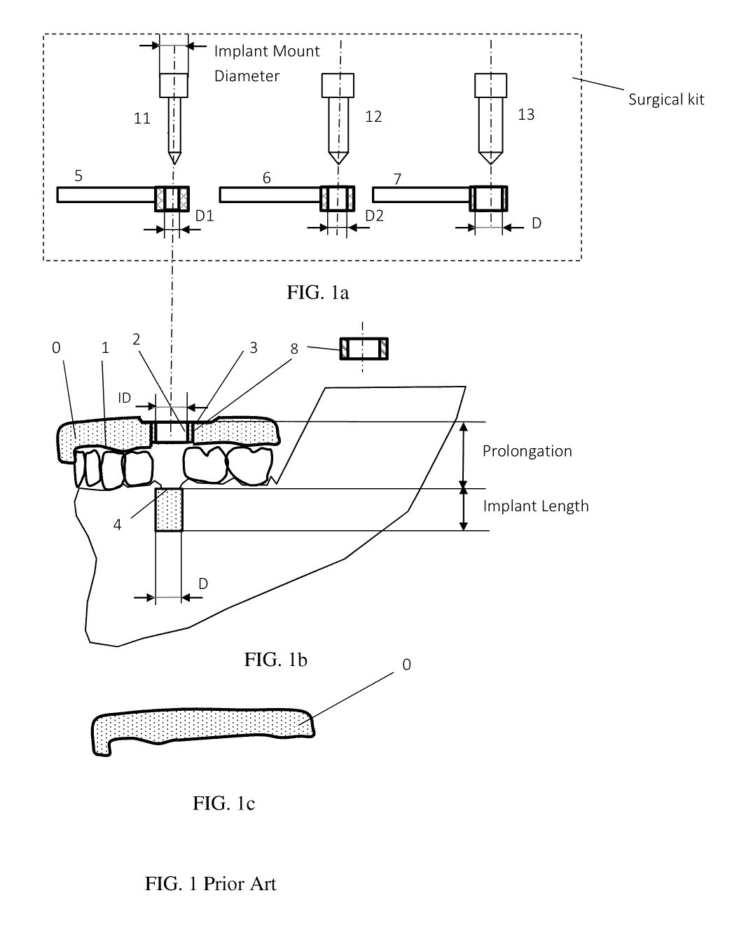

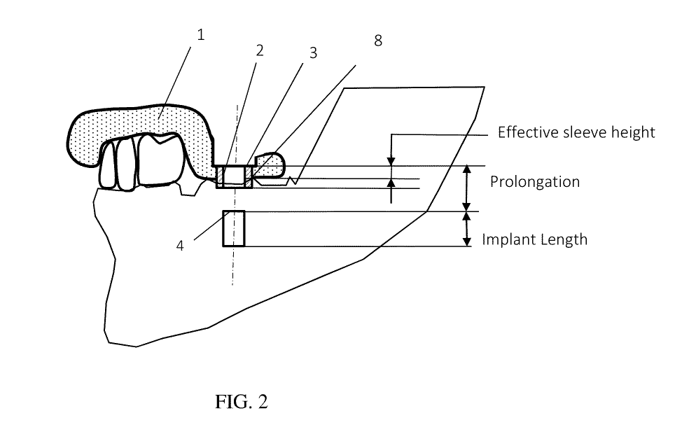

Next, the top planar faces of drill guiding holes, or essentially the top faces of drilling sleeves need to be determined. As in FIGS. 1 and 2, the top face of a sleeve is determined by given prolongation of the surgical kit and the location of the implant. The prolongation value might be a bad choice in many situations, for example, when an implant is placed very low, the soft tissue in the area is too thick, the thickness of the surgical guide base model is insufficient, or the space between the model and the implant is sometimes too big. In such a case, a drilling sleeve can penetrate into the patient's tissue as shown in FIG. 2. Technicians have to trim the sleeves like this to the adaption surface. In consequence the effective sleeve height as shown in the figure cannot be maintained at some minimum height, which is necessary to properly guide the drills. This indicates that sometimes surgical guide design needs some flexibility, or even needs to ignore the specification of underlying surgical kits.

The solution is to customize the prolongation value. Increasing the prolongation will lift the location of the drilling sleeves so as to maintain the height of the sleeve, and avoid trimming the sleeve.

### Surgical Guide

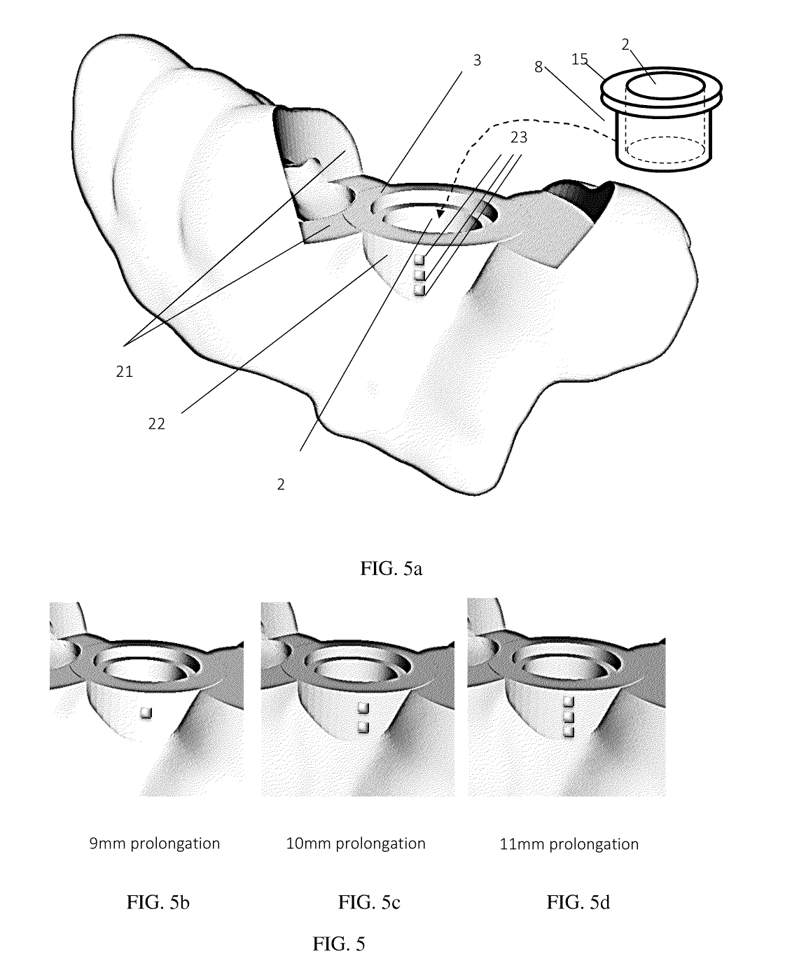

When a drilling sleeve is not used, the surgical guide in this invention includes the following features: a base model derived from either bone/tooth model for a bone/tooth borne surgical guide, or derived from tissue model for a soft-tissue borne surgical guide; drill guiding holes, whose parameters are chosen from the preferred diameter list as described above; form features to indicate drilling prolongations. FIG. 5 shows a surgical guide example.

If the prolongation for an implant is customized, the doctor who will perform the treatment needs to be reminded. Indexing feature is introduced to indicate the value of a prolongation so that the doctor can control the drilling depth accordingly without referring to a printed plan or computer program. This is shown in FIG. 5. Indexing feature means any geometric shape added to the surgical guide to indicate the prolongation information. For an individual implant site, there can be any shape and number of indexing features, as well as any sort of arrangement of the features. In any embodiment, the only necessary requirement is that the shape, amount and arrangement of indexing features will be purposely and uniquely mapped into the values of the prolongation. The features can be small slots, protrusions, pockets, or even numbers. The amount of indexing features can tie into the value of prolongation. In one embodiment, one indexing feature indicates that the prolongation is 9 mm, two for 10 mm, 3 for 11 mm, etc. The locations of the indexing features need to be close to their implant sites so that they can be easily identified. When one site has multiple indexing features, for example, 3 indexing features to indicate 11 mm prolongation, the features can be arranged in any manner, such as horizontally parallel, or vertically. The prolongation values can be different for each of the implants, so are the indexing features.

Another category of surgical guide design in this invention uses drilling sleeves. A guide includes the following features: a base model derived from either bone/tooth model for a bone/tooth borne surgical guide, or derived from tissue model for a soft-tissue borne surgical guide; drilling sleeves, whose inner diameters are chosen from the preferred diameter list as described above; form features to indicate drilling prolongations.

Drilling sleeves typically are tubes, with or without flange 15 as shown in FIG. 5. Their inner holes serve as drill-guiding holes, and thus are determined by the preferred diameter series in FIG. 3.

### Universal Surgical Kit

Accompanying the surgical guide as above is a surgical kit, which can be adopted in any guided surgery with any implant brand. The surgical kit is designed for the drills of preferred diameters and is referred as universal surgical kit. As mentioned earlier, only the drills and drilling keys of a surgical kit are interested in this invention. For each diameter in the preferred list, there is a set of drills with different length, and drilling keys of the same size. A surgical kit includes such sets of drills and keys for all the preferred diameters.

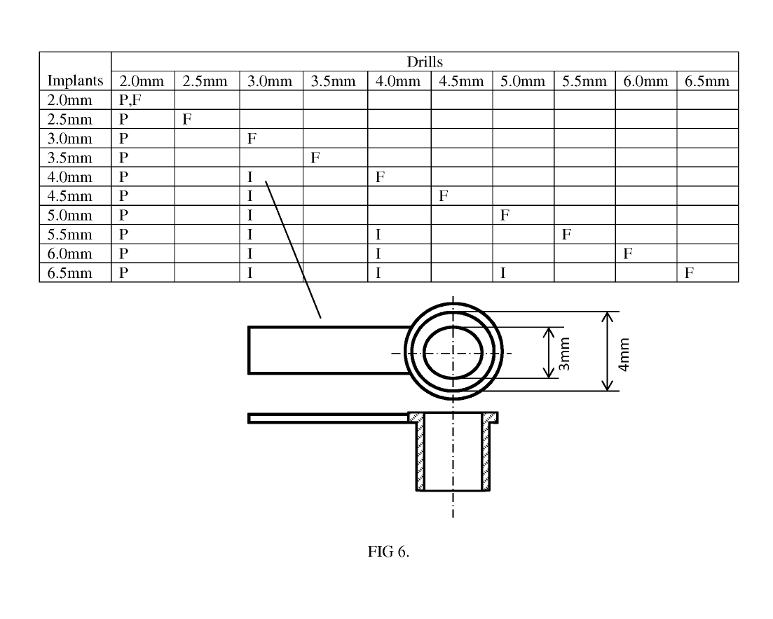

FIG. 6 shows a chart for drilling keys. The columns represent the drills, the rows the preferred diameters of implants. “P” stands for “Pilot drill”, “F” for “Final Preferred drill”, “I” for “Intermediate drill”. The row of 4.0 mm for example means that an implant with preferred diameter 4.0 mm needs one pilot drill of 2.0 mm, one intermediate drill of 3.0 mm, and one final drill of 4.0 mm. Note in this figure, final preferred drill means last drill for the “preferred diameter”, not the actual implant diameter.

Since surgical guides are designed for the final preferred drills, pilot and intermediate drills need drilling keys. For any “P” or “I” in the figure, a drill key is required. For example, the drill key for the above intermediate drill is illustrated in the figure. It has an outer diameter of 4.00 mm, and an inner diameter of 3.0 mm. The left side of the key is a handle. Its actual shape does not matter.

In the actual embodiments, the shape of the drilling keys may have different designs, but their inner and outer diameters all belong to the preferred diameter list. The actual number of keys and their specifications are derived from the table in FIG. 6, where for each drill size the pilot drill and intermediate drills can have different combination, for example, the 4.5 mm implant can have 3.5 mm intermediate drill too, instead of 3.0 mm.

### Drilling Instructions

Drilling sequence is also considered part of a surgical guide design, because a surgical guide itself does not contain adequate information for executing a treatment plan. Conventionally if a surgical guide is designed for specific surgical kit, the drilling instructions can be derived from the specification of the surgical kit. For the guide design in this invention, the drilling sequence is derived from the universal surgical kit.

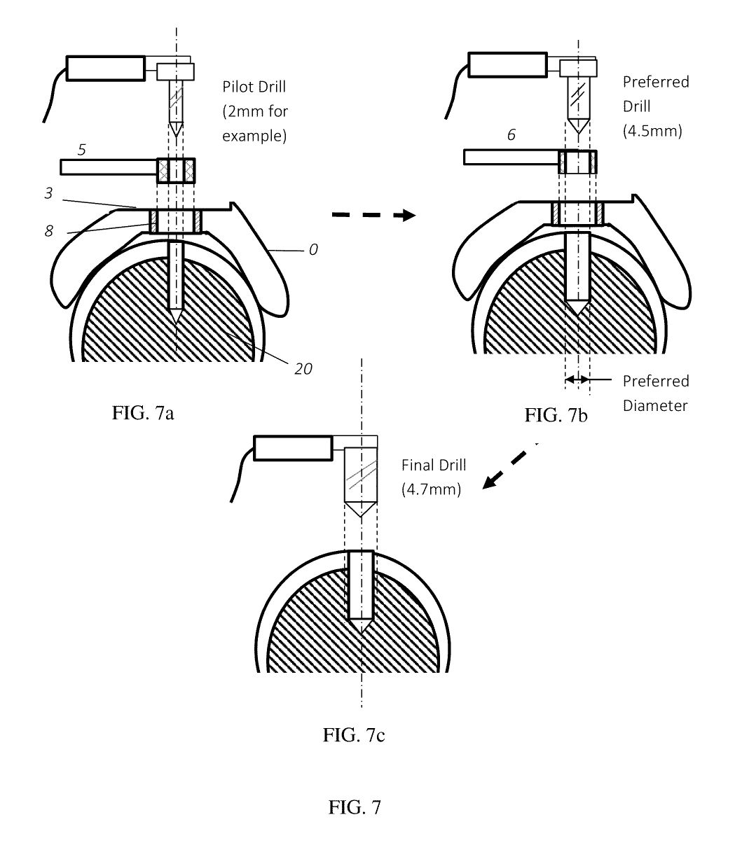

FIG. 7 illustrates the drilling sequence, which indicates the surgical guide is used in clinical application with the disclosed universal surgical kit, and thus without being limited by the specific surgical kit coming with the implants to be used. A pilot drill is normally necessary, and intermediate drills are optional depending on the implant size. The drill of the preferred diameter is referred as preferred drill, and the final drill has the diameter of the implant. For example, if the implant in this figure is 4.7 mm, the preferred drill will be 4.5 mm if the preferred diameter table in FIG. 3 is used, the intermediate drill is 3.0 mm, and the pilot drill is 2.0 mm. Those drill operations can be performed with the universal surgical kit. Finally, the doctor will perform the final drill of 4.7 mm without using the surgical guide.

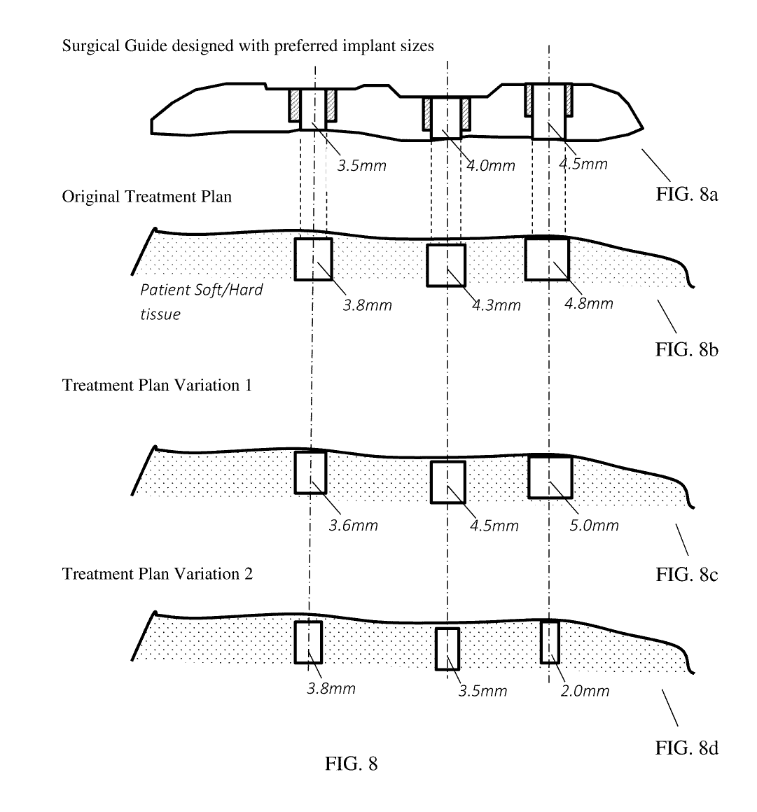

FIG. 8 illustrates that a surgical guide designed by such an approach is no longer made for single treatment plan. In this illustration, the treatment is planned with one hypothetic implant platform. The implant diameters are 3.8 mm, 4.3 mm and 4.8 mm. The surgical guide is then designed and manufactured for preferred size of 3.5 mm, 4.0 mm and 4.5 mm. For clinical or maybe supply reasons, the treatment plan is changed to 3.6 mm, 4.5 mm and 5.0 mm, and the implants will be from different manufacturer. This surgical guide can still be used with the new treatment plan, and the drilling instructions will just need minor adjustment. In the second variation of the treatment plan, the implants are 3.8 mm, 3.5 mm, and 2.0 mm. With the drill sequences resulted from the approach in FIG. 7, the surgical guide can be still used for this plan.

Consequently, a treatment plan report accompanying a surgical guide of this invention will have the information about this flexible drilling sequence and the guidelines to adjust treatment plan, which are the differentiators of such a report. The drilling instruction for each implant includes the usage of the universal surgical kit, the preferred drill diameter of the implant, the suggested drilling sequences from pilot drill to the preferred drill, as well as the instructions to the final drills. For example, for a 4.3 mm implant, the preferred drill will be 4.0 mm, pilot drill is 2.0 mm, and intermediate drills can be chosen from the preferred diameter series, which can be for this case 3.0 mm. Those three drills will be using the surgical guide. The final 4.3 mm drill will be performed without the guide. The actual drill size is 4.3 mm, unless otherwise specified in the implant manufacturer's instruction.

The guideline to adjust treatment plan will essentially specify the adjustable range for each implant. In the above example, the 4.3 mm implant can be adjusted to any size D: 4.0 mm≦D<4.5 mm. In FIG. 8 the second plan variation has more adjustment than this. For the 4.8 mm implant, any size below 5 mm can actually be allowed. If 5 mm>D≧4.5 mm, the guide is still applicable, and drilling instructions will remain the same except the final drill. If D<4.5 mm, the guide is still applicable, the drilling operations with the guide will be adjusted accordingly. For example if D becomes 2 mm, the drills and sleeves will be just chosen to do a 2 mm pilot drill.

### Surgical Guide Design System

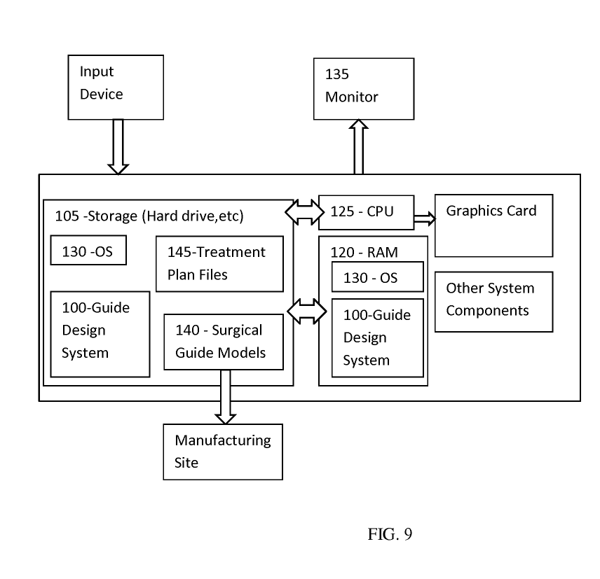

The computer system to design surgical guides with the said method is shown in FIG. 9. The system includes surgical guide design component 100 saved on any data media 105, running in the computer's RAM 120 with CPU 125 and operation system 130, and displayed on a graphical display equipment 135. The designed surgical guides 140 and treatment plan files 145 are saved in storage media and sent to manufacturing site as standard STL files with any file transferring approach such as computer network transferring.

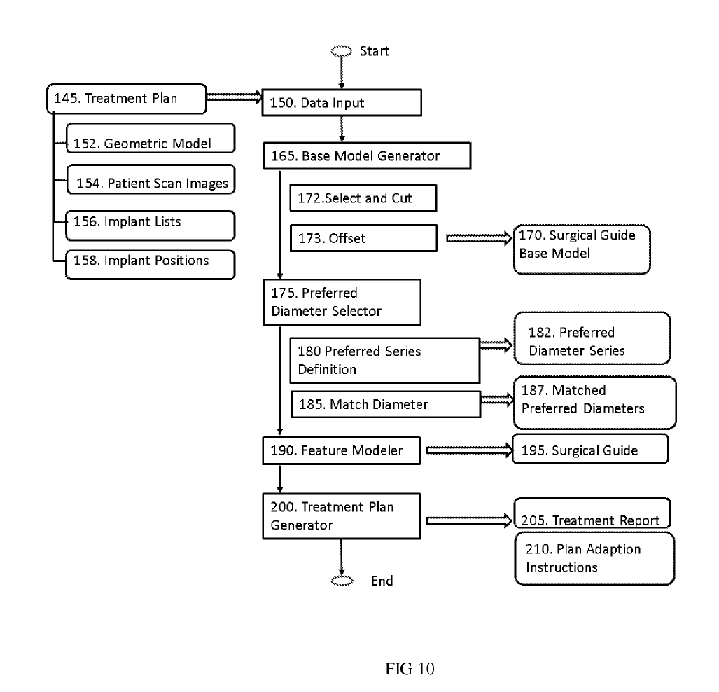

The surgical guide design component 100 can be a standalone application that runs on any operation system, or, an integrated module of an application. FIG. 10 lists the major modules of this component.

The data input module 150 receives treatment plan 145 from any possible source, either running software session or hard drive. A treatment plan here includes a geometric model 152 as a base for surgical guide design and/or patient scan image 154 where the surgical guide will be placed onto, as well as a list of implant entries 156 and their positioning parameters 158 in the coordinate system of the said geometric model. An implant entry includes its tooth number, diameter and length, manufacturer and its identification in the manufacturer's product catalog. Positioning parameters are the location and orientation data that can uniquely determine the location of the implant in the 3D space.

The base model generator 165 will create an offset model 170 from the input data, as shown in this figure. The procedure in general will select and extract a piece from the input model 152 using a “Select and Cut” tool 172, and make a solid body by an offset tool 173.

The Preferred Diameter Selector 175 in this figure includes two utilities. First is the tool 180 to define the preferred diameter series 182. A default embodiment of this tool is to have a list of diameters starting from 1.5 mm, ending at 7.0 mm, with a common difference of 0.5 mm. The tool will allow defining any series of values. The second tool 185 is to look up the preferred diameter for any given implant by its diameter, and identify the matched preferred diameters 187.

The feature modeler 190 in this figure will create surgical guide model 195. It first creates a base model from the treatment plan input as stated earlier, and then adds features so that the drill guiding holes, prolongation values and drill stopping face, as well as indexing features are realized. The orders these features are added can have different embodiments.

The treatment plan generator 200 outputs a report 205 with the implant information and drilling instructions. The differentiator of this generator is that it not only gives the drilling instructions for the planned implants according to the universal surgical kit as discussed above, but also outputs the plan adaption instructions 210. For each implant, it gives a range that the implant diameter can vary while the intended universal surgical kit can still be used, and it lists how the drills, drilling keys, and drilling steps should be changed as well.

The guide design system has an adaptive workflow in terms of surgical kit selection, even when a specific surgical kit brand instead of a universal surgical kit is used. Assuming implants in a treatment plan are from manufacturer ABC, but the surgical kit from ABC is not available. The user has surgical kit from EFG. Use one implant as example. The implant size from ABC is D1, surgical kit EFG has implant sizes D2<D1. D2 can be used as the preferred diameter of the implant from A. The surgical guide is designed for this preferred diameter. Drill diameters smaller than D2 can be chosen as pilot drill and intermediate drills. This will be listed in the generated drilling instructions. It will also be listed in the drilling instruction that the final drill of D1 will be drilled without surgical guide. Therefore for this adaptive process, a user interface tool in this surgical guide design system is needed to select any existing surgical kit and to use it as the base for preferred diameters.

What is claimed is:

1. A dental implant surgical guide, independent of implant brands and their surgical kits, comprising:
a. a base model, derived from either bone/tooth model for a bone/tooth borne surgical guide, or derived from tissue model for a soft-tissue borne surgical guide, to fit onto a patient's oral-dental anatomy,
b. one or more drilling sleeves to guide the drilling operations, wherein
i. the parameters of drill-guiding holes, or the drilling sleeves, are chosen from a series of preferred diameters instead of implant diameters,
ii. for any given implant, its preferred diameter is the closest and smaller one in said series of preferred diameters,
iii. said preferred diameters can be mapped to ranges of implant sizes,
iv. the outer diameters of drilling sleeves are chosen so that for a group of consecutive preferred diameters, drilling sleeves will have same external diameters, whereby the needed number of external diameters are reduced, and
v. the surgical guide supports drilling operations of an implant up to its preferred diameter,
c. customized drilling prolongation (the distance between the top of an implant to the top of its corresponding drill-guiding hole on the surgical guide) design, ignoring the default prolongation values of the underlying surgical kits, so that the surgical guide can have effective drill guide height so as to properly guide the drills, and
d. indexing features, wherein the shape, size and arrangement of form features are added to surgical guide model to indicate the drilling prolongation values.

2. The surgical guide of claim 1, where the preferred diameters are defined as an arithmetic progression with common difference and an implant's preferred diameter is the closest item in the said progression and smaller than the implant size.

3. (canceled)

4. (canceled)

5. (canceled)

6. The surgical guide of claim 1, where geometric form features are added to the surgical guide in the nearby areas of drilling sleeves as indexing features to indicate the prolongation value of each implant in the treatment plan of the surgical guide.

7. The surgical guide of claim 6, where the combinations of the shape, amount, and/or arrangement of said indexing features can be uniquely mapped to prolongation values with some predefined mapping rules.

8. (canceled)

9. (canceled)

10. (canceled)

11. A computerized system to design dental implant surgical guides comprising
a. a surgical guide design component that is saved on data storage media, runs in the computer's RAM together with CPU and operation system, and performs surgical guide design,
b. a data input module that receives the treatment plan files from possible source comprising a running software session or hard drive,
c. a file exporting tool that outputs standard STL files of surgical guide designs into storage media,
d. a data transfer means that transfers said STL files from said design component or storage media to a manufacturing site, and
e. a reporting means that outputs drilling instructions according to the surgical guide design,
wherein said design component further comprises
a. a treatment plan input module, which receives a treatment plan consisting of all the image data, geometric models, and the size, type and location of implants and abutments as well,
b. a base model generator, which creates a base model of a surgical guide that will fit onto a patient's oral-dental anatomy with an adaption surface that partially matches the patient's tissue surfaces,
c. a preferred diameter selector, which defines the series of preferred diameters and looks up the preferred diameters for input implants,
d. universal surgical kit configurations that are defined according to the preferred diameters,
e. a feature modeler to add holes, drilling sleeves and prolongation indexing features to the base model according to the input treatment plan and selected preferred diameters, and
f. a treatment plan generator that creates drilling instructions according to the guide design and to a universal surgical kit, as well as the instruction to adjust treatment plans,
whereby
a. surgical guides are designed with drill-guiding holes, or the drilling sleeves, using the preferred diameters other than actual implant sizes,
b. surgical guide design is improved for situations when predefined prolongation values cannot lead to a good design, and
c. indexing features can remind the doctors about said prolongation values at surgery time.

12. (canceled)

13. (canceled)

14. (canceled)

15. The system of claim 11, comprising
a. a tool to define preferred diameter series,
b. a tool to match the preferred diameters for implants,
c. a universal surgical kit configuration to determine the geometry design of surgical guides, wherein
a) said surgical kit configuration includes a set of drills and drilling keys for all the preferred diameters,
b) shape of the drilling keys may have different designs, but their inner and outer diameters all belong to the preferred diameter list,
c) the surgical guide is designed according to said surgical kit configuration, and
d. the guide design system has an adaptive workflow in terms of surgical kit selection, even when a specific surgical kit brand instead of a universal surgical kit is used, wherein
a) a user interface tool in said surgical guide design system is used to select an existing surgical kit in order to use it as the base for preferred diameters,
b) drill diameters of said surgical kit can be chosen as pilot drills and intermediate drills for the implants,
whereby the preferred diameters are independent of implant brands and the corresponding surgical kit, and the surgical guide is designed according to the surgical kit of user's choice instead of the kit from the implant manufacturer.

16. (canceled)

17. (canceled)

18. (canceled)

19. (canceled)

20. The system of claim 11, wherein
a. the preferred diameter definition tool can map a range of implant diameters to one preferred diameter, and
b. the design component designs a surgical guide with preferred diameters other than implant diameters,
whereby a surgical guide can work for a range of implant diameters, and said surgical guide is no longer made for single treatment plan, but a range of treatment plans corresponding to said range of implant diameters.

21. The system of claim 20, further comprising a treatment plan generator to generate plan adaption instructions, which
a. gives the drilling instructions for the planned implants according to the universal surgical kit, and
b. outputs the plan adaption instructions, which
a) for each implant gives a range that the implant diameter can vary while the intended universal surgical kit can still be used with the surgical guide, and
b) list how the drills, drilling keys, and drilling steps should be changed as well when a treatment has to be adjusted with implants of different diameters.
